(19) United States
(12) Patent Application Publication
(10) Pub. No.: US 2011/0197495 A1
(43) Pub. Date: Aug. 18, 2011

(54) Fossorial Rodent Control Method and Apparatus

(75) Inventor: Dana A. Shaw, Paso Robles, CA (US)

(73) Assignee: Cheetah Industries, Inc., Paso Robles, CA (US)

(21) Appl. No.: 13/026,217

(22) Filed: Feb. 12, 2011

Related U.S. Application Data
(60) Provisional application No. 61/304,675, filed on Feb. 15, 2010.

(51) Int. Cl. A01M 13/00

(52) U.S. Cl. 43/125

(57) ABSTRACT

A fossorial rodent control apparatus is disclosed which utilizes an internal combustion engine to generate waste combustion gases. The waste combustion gases are routed by an exhaust collection conduit into a functionally coupled air intake associated with an air blower. The waste combustion gases are mixed with ambient air to form a high velocity noxious gaseous flow when discharged from the air blower. The noxious gas flow is routed by a noxious gas discharge conduit into a burrow of a fossorial rodent.

### CROSS-REFERENCE TO RELATED APPLICATIONS

This application is a non-provisional application which takes benefit and priority under 35 U.S.C. §119(e) from co-pending U.S. provisional application Ser. No. 61/304,675 filed, Feb. 15, 2010 to the instant inventor. The aforementioned provisional patent application is hereby incorporated by reference as if fully set forth herein.

### FEDERALLY SPONSORED RESEARCH AND DEVELOPMENT

Not Applicable

### COPYRIGHT NOTICE

Not Applicable

### RELEVANT FIELD

This application is directed generally toward fossorial rodent control and more specifically toward a fumigating apparatus and method for controlling fossorial rodents.

### RELEVANT ART OVERVIEW

Fossorial rodents have devastated agriculture for centuries. The agricultural industry pays a very heavy price in the loss of plants and the products that are derived therefrom. For example, the wine industry is particularly susceptible to harm from fossorial rodents since grape vines take years to grow before meaningful production of fruit is obtained. Moreover, rodents can cause irreparable damage to plant root systems and create earthen mounds and/or holes that pose hazards to both people and equipment. Current control measures used by growers include trapping, poison bait and shooting. Regulation of poison bait limits the effectiveness of baiting since ingestion of poisoned rodents could be toxic to endangered species such as raptors and other scavenger animals that consume a poisoned rodent's carcass.

### SUMMARY

In view of the foregoing, various exemplary embodiments of an apparatus and method for controlling fossorial rodents are described herein. In one exemplary embodiment, an exhaust collection conduit is provided for routing waste combustion gases generated by an internal combustion engine into a forced air stream generated by an air blower. The internal combustion engine and air blower may be combined in a common assembly, such that the internal combustion engine drives the air blower.

An opposite end of the exhaust collection conduit may be coupled with an air blower and arranged such that the routed waste combustion gases are mixed in the forced air stream discharged from the air blower. The mixed waste combustion gases and forced air stream forms a noxious gaseous flow when discharged from the air blower. The noxious gas flow may then be routed into a burrow of a fossorial rodent for a sufficient time to asphyxiate the rodent(s) within their burrow.

### BRIEF DESCRIPTION OF DRAWINGS

The features and advantages of the various exemplary embodiments will become apparent from the following detailed description when considered in conjunction with the accompanying drawings. Where possible, the same reference numerals and characters are used to denote like features, elements, components or portions of the inventive embodiments. It is intended that changes and modifications can be made to the described exemplary embodiments without departing from the true scope and spirit of the inventive embodiments described herein and as is defined by the claims.

FIG. 1—depicts a generalized block diagram of a fossorial rodent control apparatus in accordance with an exemplary embodiment.

FIG. 1A—depicts an implementation of a fossorial rodent control apparatus in accordance with an exemplary embodiment.

FIG. 2A—depicts a frontal view of a fossorial rodent control apparatus in accordance with an exemplary embodiment.

FIG. 2B—depicts a top view of a fossorial rodent control apparatus in accordance with an exemplary embodiment.

FIG. 3A—depicts a right side view of a fossorial rodent control apparatus in accordance with an exemplary embodiment.

FIG. 3B—depicts a left side view of a fossorial rodent control apparatus in accordance with an exemplary embodiment.

### DETAILED DESCRIPTION

Various exemplary embodiments of a fossorial rodent control apparatus and method are disclosed herein. In the following detailed description, numerous specific details are set forth in order to provide a thorough understanding of the present inventive embodiments. It will be apparent, however, to one skilled in the art that the present inventive embodiments may be practiced without these specific details. In other instances, well-known structures, devices or components may be shown in block diagram form in order to avoid unnecessarily obscuring the present inventive embodiments.

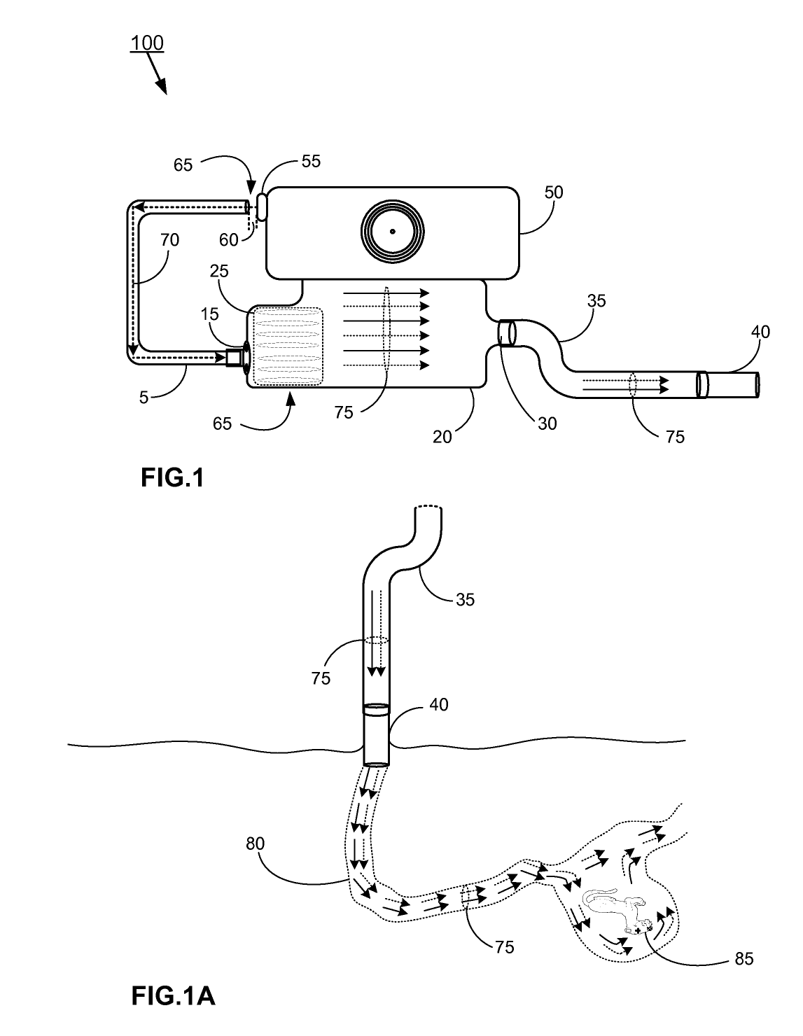

Referring to FIG. 1, an exemplary generalized block diagram of a fossorial rodent control apparatus 100 is depicted. In this exemplary embodiment, the fossorial rodent control apparatus 100 is built using an internal combustion engine 50 and air blower combination 20. By way of example and not limitation, a Maruyama model BL3200 leaf blower.

A proximate end of an exhaust collection conduit 5 is placed in juxtaposition with a muffler 55 of the internal combustion engine 50 while a distal end of the exhaust collection conduit 5 is coupled 15 or placed in proximity with an air take 25 of the air blower 20. During operation, waste combustion gases 70 expelled through the muffler 55 of the internal combustion engine 50 are pulled into the exhaust collection conduit 5 by suction created by operation of the air blower 20. The waste combustion gases 70 are pulled into the air intake and mixed with the high velocity air flow generated by the air blower 20. The resulting noxious gas 75 is discharged from an air blower exhaust port 30 at high velocity into a proximate end of a noxious gas discharge conduit 35. The noxious gas discharge conduit 35 is constructed from a flexible polymeric material which allows positioning of a distal end of the noxious gas discharge conduit 30 within a burrow of a fossorial rodent 80 (FIG. 1A).

The noxious gas discharge conduit 35 may also be made extensible similar to polymeric hoses used for vacuum cleaners. In an exemplary embodiment, a generally rigid tubular wand applicator 40 may be attached to the distal end of the noxious gas discharge conduit. The wand applicator 40 simplifies displacement of soil surrounding an entrance of the burrow 80 during insertion. The inner diameter of the noxious gas discharge conduit 35 is dimensioned to coaxially fit over the air blower exhaust port 30 with a snug fit. The inner diameter of the wand applicator 40 is dimensioned to coaxially fit over the noxious gas discharge conduit 35 with a snug fit. Alternate arrangements may be provided where the outer diameter of the noxious gas discharge conduit 35 is dimensioned to coaxially fit within the air blower exhaust port 30 with a snug fit. Analogously, the outer diameter of the wand applicator 40 is dimensioned to coaxially within the noxious gas discharge conduit 35 with a snug fit.

The exhaust collection conduit 5 may be constructed from a corrosion resistant metal, for example, stainless steel or other corrosion resistant metal alloys. In an exemplary embodiment, the exhaust collection conduit 5 is constructed from 1.0 inch outer diameter pipe having a wall thickness in a range of 0.0625-0.25 inches. The exhaust collection conduit 5 typically has a U-shape in order to extend around the fossorial rodent control apparatus 100 with minimized length between the muffler 55 of the internal combustion engine 50 and air intake 25 of the air blower 20. One skilled in the art will appreciate that other shapes may be utilized to transfer the waste combustion gases 70 to the air intake 25 of the air blower 20.

An air gap 60 is provided between the proximate end of the exhaust collection conduit 5 and muffler 55 which allows ambient air 65 to be drawn into the exhaust collection conduit 5 which reduces the temperature of the collected waste combustion gases 70. The air gap 60 may be in a range of 0.0625-0.25 inches with a preferred air gap of approximately 0.125 inches. An insulating material, for example, acrylonitrile butadiene styrene (ABS) plastic may be provided around the exhaust collection conduit 5 to reduce the possibility of operator skin burns (not shown.) When the exhaust collection conduit 5 is installed on a Maruyama BL3200 hand held blower, the total weight of the fossorial rodent control apparatus 100 is less than 15 lbs, making for a self-contained, light weight and highly portable apparatus which can easily be transported by hand to needed treatment locations.

Referring to FIG. 1A, an exemplary implementation of a fossorial rodent control apparatus 100 is depicted. In this exemplary embodiment, the fossorial rodent control apparatus 100 is transported to a treatment location. The wand applicator 40 is inserted into the burrow 80 of the fossorial rodent 85. In an exemplary embodiment, the wand applicator 40 is inserted approximately 6 inches into the burrow 80. The internal combustion engine 50 is started and throttled to a predetermined speed which causes the air blower 20 to draw waste combustion gases 70 into the exhaust collection conduit 5. The waste combustion gases 70 are drawn into the air intake 25 of the air blower 20 and mixed with ambient air 65 to form the mixture of noxious gases 75. The noxious gases 75 are propelled by the air blower 20 out through the air blower exhaust port 30 at high velocities (300-500 SCFM) into the noxious gas discharge conduit 35 where the noxious gases 75 are directed via the wand applicator 40 into the burrow 80.

The noxious gases 75 contain varying concentrations of oxides of carbon and nitrogen, burnt fuel and oil. All of which are heavier than air and tend to displace the air existing within the burrow 80.

The amount of time required for fumigating the burrow 80 varies somewhat, depending on throttle settings of the internal combustion engine 50. For example, a treatment of approximately 3 minutes per burrow 80 when the internal combustion engine 50 is operated at 6,000-9,000 RPM is generally sufficient. The treatment time and throttle settings of the internal combustion engine 50 will also vary depending on whether a two or four cycle engine is employed. The fossorial rodent 85 is asphyxiated within its burrow 80 by the noxious gases 75. The carcass of the fossorial rodent 85 presents no significant threat toxicity threat to possible scavenging animals and decays in situ.

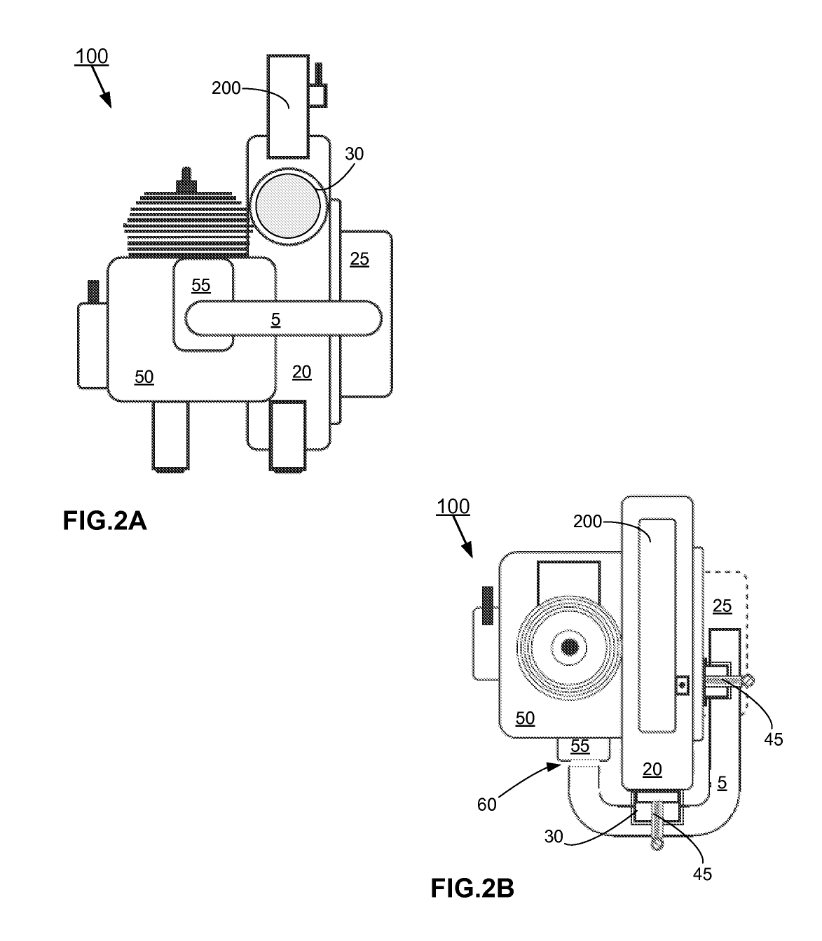

Referring to FIG. 2A, a frontal view of an exemplary fossorial rodent control apparatus 100 is depicted. In this exemplary embodiment, a combination internal combustion engine 50 and air blower 20 forms the fossorial rodent control apparatus 100. The exhaust collection conduit 5 is shown in front of the muffler 55 associated with the internal combustion engine 50 and winds around the body of the air blower 20 until coupled 15 or placed in proximity with the air intake 25 of the air blower 20. In this exemplary embodiment, the exhaust collection conduit 5 is directed beneath the air blower exhaust port 30 in a location which minimizes its length and possible accidental contact with a user of the fossorial rodent control apparatus 100. A carrying handle 200 may be provided at the top of the fossorial rodent control apparatus 100 for transporting and positioning of the unit.

Referring to FIG. 2B, an exemplary top view of a fossorial rodent control apparatus 100 is depicted. In this exemplary embodiment, as before, a combination internal combustion engine 50 and air blower 20 forms the fossorial rodent control apparatus 100. The exhaust collection conduit 5 is again shown in front of the muffler 55 associated with the internal combustion engine 50 and separated by the air gap 60 to allow for ambient air 65 to be drawn into the exhaust collection conduit 5 during operation. In this exemplary embodiment, the exhaust collection conduit 5 is routed beneath the air blower exhaust port 30 and around the body of the air blower 20 until coupled 15 or placed in proximity with the air intake 25 of the air blower 20. In an exemplary embodiment, the exhaust collection conduit 5 is maintained in position by supports 45 attached to the air blower exhaust port 30 and a cover associated with the air blower 20. The supports 45 may include clamps which circumferentially clamp the exhaust collection conduit 5 to the supports 45.

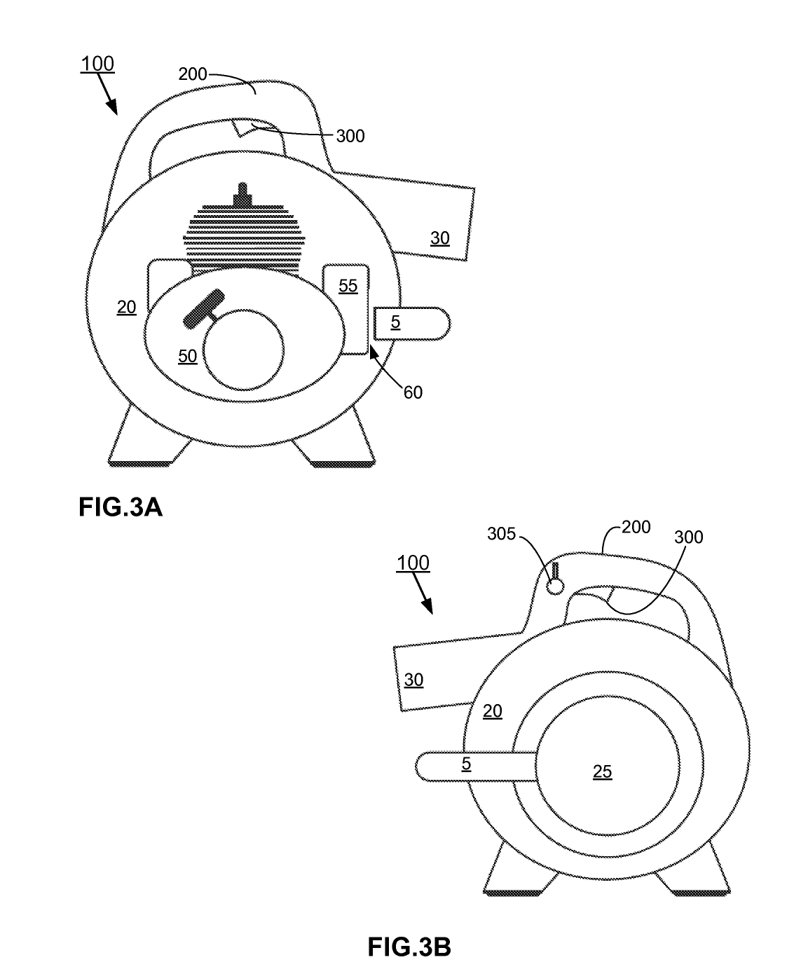

Referring to FIG. 3A, an exemplary right side view of a fossorial rodent control apparatus 100 is depicted. In this exemplary embodiment, the internal combustion engine 50 is shown coupled to the air blower 20 which forms the fossorial rodent control apparatus 100. The exhaust collection conduit 5 is shown in juxtaposition with the muffler 55 associated with the internal combustion engine 50 and separated by the air gap 60 to allow for ambient air 65 to be drawn into the exhaust collection conduit 5 during operation. In this exemplary embodiment, the exhaust collection conduit 5 is again routed beneath the air blower exhaust port 30 and around the body of the air blower 20 until coupled 15 or placed in proximity with the air intake 25 of the air blower 20. The handle 200 includes a trigger 300 for controlling the throttle settings of the internal combustion engine 50 during operation. As discussed above, the throttle settings controls the amount of waste combustion gases 70 discharged through the air blower exhaust port 30 and into the burrow 80 of the fossorial rodent 85.

Referring to FIG. 3B, an exemplary left side view of a fossorial rodent control apparatus 100 is depicted. In this exemplary embodiment, the air blower 20 is shown coupled with the internal combustion engine 50 which forms the fossorial rodent control apparatus 100. The exhaust collection conduit 5 is shown coupled 15 or placed in proximity with the air intake 25 of the air blower 20. In this exemplary embodiment, the exhaust collection conduit 5 is routed beneath the air blower exhaust port 30 and around the body of the air blower 20 until coupled 15 or placed in proximity with the air intake 25 of the air blower 20. As before, the handle 200 includes a trigger 300 for controlling the throttle settings of the internal combustion engine 50 during operation. In addition, a throttle lock 305 may be provided to maintain the internal combustion engine 50 at particular throttle setting. As discussed above, the throttle setting controls the amount of waste combustion gases 70 generated by the internal combustion engine 50, which are combined with high velocity air to form the noxious gas mixture 75 and discharged through the air blower exhaust port 30 into the burrow 80 of the fossorial rodent 85.

The various exemplary inventive embodiments described herein are intended to be merely illustrative of the principles underlying the inventive concept. It is therefore contemplated that various modifications of the disclosed embodiments will without departing from the inventive spirit and scope be apparent to persons of ordinary skill in the art. They are not intended to limit the various exemplary inventive embodiments to any precise form described. In particular, fossorial rodent control apparatus 100 may utilize either a two cycle or four cycle internal combustion engine to drive the air blower 20. In addition, the treatment times and/or internal combustion engine throttle settings may be different than those described herein. No specific limitation is intended to the operating sequences or construction materials described herein. Other variations and inventive embodiments are possible in light of the above teachings, and it is not intended that the inventive scope be limited by this specification, but rather by the Claims following herein.

What is claimed:

1. A method for fumigating a fossorial rodent comprising:
providing an exhaust collection conduit for routing waste combustion gases generated by an internal combustion engine into a forced air stream generated by an air blower;
maintaining a proximate end of the exhaust collection conduit in juxtaposition to an exhaust of the internal combustion engine;
directing a distal end of the exhaust collection conduit into an air blower, such that the routed waste combustion gases are mixed in the forced air stream generated by the air blower;
wherein the mixed waste combustion gases and forced air stream forms a noxious gaseous flow when discharged from the air blower.

2. The method of claim 1 further comprising:
coupling a proximate end of a noxious gas discharge conduit with an air exhaust port of the air blower.

3. The method of claim 2 further comprising:
coupling a wand applicator to a distal end of the noxious gas discharge conduit;
wherein at least a portion of the wand applicator is dimensioned to fit within an opening of a burrow of the fossorial rodent.

4. The method of claim 1 further comprising:
disposing the proximate end of the exhaust collection conduit in juxtaposition within a predefined air gap from a muffler of the internal combustion engine such that air suction generated by operation of the air blower simultaneously draws in both the waste combustion gases and ambient air.

5. The method of claim 1 further comprising:
coupling the distal end of the exhaust collection conduit with an air intake of the air blower.

6. The method of claim 1 further comprising:
directing the noxious gaseous flow into a burrow of the fossorial rodent.

7. The method of claim 6 further comprising:
fumigating the burrow with the noxious gaseous flow for a sufficient time to at least asphyxiate the fossorial rodent.

8. The method of claim 7 wherein the sufficient time is at least 3 minutes.

9. The method of claim 1 wherein the internal combustion engine and air blower are combined in a common assembly, such that the internal combustion engine drives the air blower.

10. An apparatus for controlling a fossorial rodent comprising:
an internal combustion engine having an exhaust discharge;
an exhaust collection conduit maintained in juxtaposition to the exhaust discharge at a proximate end and with an air blower at a distal end, the exhaust collection conduit configured to route discharged waste combustion gases generated by the internal combustion engine through the air blower, such that the routed waste combustion gases are mixed in a forced air stream generated by the air blower;
wherein the mixed waste combustion gases and forced air stream forms a noxious gaseous flow when discharged from the air blower.

11. The apparatus of claim 10 wherein the air blower is functionally coupled to the internal combustion engine.

12. The apparatus of claim 10 wherein the air blower includes a noxious gas discharge conduit for directing the noxious gaseous flow into a burrow of the fossorial rodent.

13. The apparatus of claim 10 wherein the exhaust collection conduit routes waste combustion gases discharged by the internal combustion engine from the exhaust discharge directly into an air intake of the air blower.

14. The Apparatus of claim 10 wherein the proximate end of the exhaust collection conduit is disposed in juxtaposition within a predefined air gap from a muffler of the internal combustion engine such that air suction generated by the air blower simultaneously draws in both the discharged waste combustion gases and ambient air during operation of the air blower.

15. The Apparatus of claim 10 wherein the internal combustion engine and air blower are combined in a common assembly, such that the internal combustion engine drives the air blower.

16. An apparatus for controlling a fossorial rodent comprising:
an internal combustion engine having an exhaust discharge;
an air blower functionally coupled to and driven by the internal combustion engine;
an exhaust collection conduit maintained proximate to but separate from the exhaust discharge at a proximate end and coupled directly at a distal end with an air intake associated with the air blower;
wherein the exhaust collection conduit is configured to route the discharged waste combustion gases generated by the internal combustion engine through the air blower, such that the routed waste combustion gases are mixed in a forced air stream generated by the air blower to form a noxious gaseous flow.

17. The apparatus of claim 16 wherein the air blower has functionally coupled thereto a noxious gas discharge conduit for directing the noxious gaseous flow into a burrow of the fossorial rodent.

18. The apparatus of claim 16 wherein the noxious gaseous flow is variably controlled by a throttle associated with the internal combustion engine.

19. The apparatus of claim 16 wherein the internal combustion engine is a two cycle engine.

20. The apparatus of claim 17 wherein the noxious gas discharge conduit includes a wand functionally coupled to a distal end of the noxious gas discharge conduit for further directing the noxious gaseous flow into the burrow of the fossorial rodent.
